(19) United States
(12) Patent Application Publication
(10) Pub. No.: US 2002/0026842 A1
(43) Pub. Date: Mar. 7, 2002

(54) Continuously variable transmission

(76) Inventor: Kanji Tomidokoro, Tokyo (JP)

Correspondence Address: KANJI TOMIDOKORO, 2-10-12-104 NISHIKATA BUNKYO-KU, TOKYO, 113-0024, JP

(21) Appl. No.: 09/891,538

(22) Filed: Jun. 27, 2001

(30) Foreign Application Priority Data
Sep. 7, 2000 (JP) 2000-312664
Nov. 1, 2000 (JP) 2000-372124

(51) Int. Cl. F16H 15/12

(52) U.S. Cl. 74/393; 476/38

(57) ABSTRACT

A continuously variable transmission comprising: an A input member that includes an input shaft and a toothed transmission section, a B output member that includes an output shaft and a toothed transmission section, a plurality of first toothed transmission sections, a moving device loaded with a rotary member plus a moving member and a baffle, and a box for axially supporting and housing each member and device; and the toothed transmission gears oppose each other, the toothed transmission gears and the first toothed transmission section each axially supported at the box are interlocked by gears, and the rotary member is rotatably loaded in contact with the moving device; a space is provided between the toothed transmission gears for inserting the rotary member and a lubricant oil therein to be in contact therewith, the moving device reciprocatingly moves in the space to interlock the toothed transmission gears and the first toothed transmission section by contact via the rotary member, thereby making it possible to freely perform continuously variable transmission; and a value of torque transmitting force is increased and decreased according to the number of the first toothed transmission sections when combined; according to the present invention, smooth continuously variable transmission can be performed with the simple structure.

### BACKGROUND OF THE INVENTION

1. Field of the Invention

The present invention relates to a transmission capable of continuously transmitting rotation generated from a motor.

2. Description of the Related Art

Conventional continuous variable transmissions such as a belt interlocking type of continuously variable transmission or a continuously variable transmission with a point contact method utilizing a curved surface or a sphere are known.

As prior arts disclosed, Japanese Patent Application Laid-open No. 8-247244, Japanese Patent Application Laid-open No. 62-233556, and Japanese Patent Application Laid-open No. 2000-314460 and the like as a troidal CVT (continuously variable transmission) can be cited. Further, as an example for reference, a troidal CVT was introduced in the NHK Special, “Across the Century • Break the Wall of Friction” which was televised on Aug. 20, 2000. In addition, according to “Energy Conservation Strategy by Friction Control”, a U.S Report of fiscal 1977, it is reported that two thirds of the energy consumption by the automobiles in the entire U.S. is wasted by friction, and commercialization of the troidal CVT makes it possible to save 4.5% of the energy consumption, that is, about four hundred and forty five million drams.

A belt interlocking type of continuously variable transmission makes the rotation transmission ratio variable by sandwiching a belt with a pair of drums, and pressing the pair of drums from the left and right side to change the drums to push up the belt. However, in the belt type, a slip occurs as a result of the belt being extended by load weight exerted onto the belt, which is not suitable for transmission of high torque. In addition, the problem remains in the durability of the belt.

The continuously variable transmission by point contact via a sphere, Japanese Patent Laid-open No.8-247244 as an example, adopts a method in which a rotational shaft placed at two of the rotary elements (hereinafter called transmission sections) and the rotary element (hereinafter called a sphere) are used for driving motion or following motion, and one side surface or both side surfaces of the transmission section is or are rotated in press contact with the sphere to thereby perform interlock transmission. However, the placement of the above rotational shaft prevents free rotation on the entire surface of the sphere and restricts setting of the transmission ratio (the extent of the ratio). In addition, the contact point for the interlock cannot be used on the entire surface of the sphere, and partial wear caused by partial use of the sphere makes the sphere deformed, which causes the problem of a contact failure. Further, the operation of the apparatus requires complicated interlocking connection by the combination of various devices such as a rotation interlocking device and linearly moving device for moving the rotational shaft of the sphere and the transmission section, a rotational interlocking device and linearly moving device on a driving side and a following side of the transmission section and the like, and a synchronous control device for the movement and interlock.

The disadvantage of the transmission method utilizing one side surface of the transmission section is that when the sphere reaches the outer side portion of the transmission section at the time of interlocking transmission, contact pressure concentrates on the outer side portion, and the force is exerted in a direction in which the base axis of the transmission section is inclined, whereby contact pressure causes uneven wear at the shaft engaging portion after a long period of use. In addition, oscillating rotation of the transmission section due to wear causes a contact failure of the transmission section and the sphere, and also deformation wear of the contact portions of the sphere and the transmission section. The result is a need for the development of a stabilizing device for preventing an interlock failure of the transmission section with the sphere due to the above contact failure, which is necessary for the continuation of stable rotation.

In the troidal CVT, each transmission section of an input member and an output member is formed by a pair of half-curved surfaces and the input and output members are rotated with their base axes being conformed. As for the interlocking method, a rotary member with a partially curved surface for interlocking the input and output members is rotated to be transformed at 90 degrees to perform circular movement, by which the rotary member is in contact with the transmission section at a point at which they are intersecting horizontally and vertically to perform continuous variable transmission by interlocking by contact friction, and it requires a highly developed machining technique to manufacture the half curved surface with high precision. As for the transmission ratio, a large rotation transmission ratio is possible, but a safety value of the rotation transmission ratio in the practical rigidity strength is needed to be not more than 1 to 3. Specifically, in the transmission interlock of the input and output member and the rotary member, only when interlocking at the transmission ratio of 1 to 1 does the contact surface of the transmission surface of the output member and the rotary member intersect at the right angle and the input and output members and the rotary member are interlocked in parallel. At contact positions other than the above, the parallelism of the input and output members and the rotary member is lost, and the rotary member in contact with the contact surfaces of the input and output members at an acute angle or an obtuse angle acts to push the rotary member outside, and thus it is difficult to make the rotation angle of the rotary circular movement large.

Further, it becomes necessary to always match the base axes of the input and output members with high precision to maintain high contact efficiency. When large output torque or large rotation transmission ratio is required, it is necessary to increase the number of pairs of the transmission sections to be coupled, which requires an increased number of rotary members, which requires a precise synchronous control, and the increase in the number of coupled transmission sections increases the weight; thus, increasing fuel consumption, and requiring precise maintenance and control over a long period of use.

### SUMMARY OF THE INVENTION

According to the present invention, the toothed transmission gears (2,5-FIG. 1) of an A input member and a B output member are formed to be a disc shape, the mounting positions of the toothed transmission gears are placed almost in parallel to oppose each other, and an additional first toothed transmission gear (7-FIG. 1) and each member and device are axially supported at and housed in a box (12-FIG. 1). Further, a rotary member (8-FIG. 1) for interlocking the A input member and the B output member by contact is a sphere or a disc shape (disc not shown); the rotary member (8) is loaded freely in a moving device (11-FIG. 1) to be rotatable in contact with the surfaces of the toothed transmission gears (2,5), and moved within the moving device (11) by a rotating screw (9-FIG. 1); the moving device moves vertically back and forth along the axis of both the screw (9) and unthreaded shaft (10-FIG. 1); the fixed, unthreaded shaft (10) almost parallel to the rotating screw (9) prevents the rotation of the moving device (11) caused by the rotation of the rotating screw (9); the toothed transmission gears (2,5) are interlocked by the rotary member (8) and in continuous contact with the first toothed transmission gear (7); and, thereby making it possible to perform continuously variable transmission.

Compared with the troidal CVT, in the present invention, the parallelism between the A and B toothed transmission sections is always maintained, and even if the contact position of the rotary member (8) moves, the tangent lines going through the contact point between the rotary member and the surface of the gears always remains perpendicular with the base axes of the A input shaft and B output shaft, while the troidal CVT's angle line between the tangent line and base axes varies depending on the position of the power roller More specifically, the troidal CVT requires a control device to push the power roller at a constant pressure at the contact point, while the present invention requires no control device since the rotary member (8) always remains in constant pressure at the contract point.

Another difference is that while the gear ratio of the troidal CVT is limited, the gear ratio of the present invention is infinitely large More specifically, the radius between the bases axes and the contact point of the troidal CVT is limited by the movement of the roller between the gears, while the radius of the present invention can be infinitely small since the contact point of the rotary member can reach to the center of the base axes.

Further, over a long period of use, when the rotary member reaches a periphery portion of each transmission gear as a result of interlocking movement of the rotary member (8), contact pressure of the rotary member (8) is strengthened at the periphery portion of each transmission section, whereby oscillation occurs between each transmission section and the rotary member. Because oscillation causes an inclination phenomenon at the shaft of each transmission section, about one to three stabilizing members (29-FIG. 4) for preventing this phenomenon are attached to each box so that the rotation of an adjusting screw (22-FIG. 4), which, as many as necessary, is attached at the position corresponding to the rotary member (8), or the repulsive force of a spring (not shown) can make positional adjustment of the contact surface of each transmission section, and hence contact pressure of the stabilizing member (29) and the rotary member (8) is almost balanced.

Moreover, a ball or a roller (37-FIG. 4) attached at the stabilizing member at a portion in contact with the contact surface of each transmission gear reduces the contact friction with each transmission section and slide of the stabilizing member, and thereby preventing oscillation of the transmission section, maintaining parallelism of each transmission section, and preventing wear at an engaging portion of each shaft portion and bearing portion caused by contact. Maintaining parallelism reduces a contact failure occurring because of the movement of the rotary member on the one side of the gear; thus, obtaining stable rotation of the transmission sections and reliable transmission interlock.

Also, if development name DM2H by Idemitsu Kosan Co., Ltd. is used as a lubricant oil of the present invention, various properties can be utilized. When the lubricant oil enters the contact portion between the rotary member and the contact surfaces of the A and B toothed transmission sections and the first toothed transmission gear (7), and contact force is added, the lubricant molecules have the property of being bound instantly and solidified, which increases the contact friction between the contact surface of the toothed transmission sections and the rotary member (8). Further, the molecules of the lubricant have the property of being unbound instantly when the pressure is released by the movement of the contact portion, which allows the rotary member (8) to efficiently transmit high torque from and to the A and B toothed transmission sections About six tons of contact pressure occurs at the contact point between the A and B toothed transmission sections and the rotary member (8). However, peeling of the surface of the metal used or the breakage of the main body caused by the frictional pressure due to the contact between the A and B toothed transmission sections and the rotary (8) member can be prevented by using carbon bearing steel (SUJ2) or highly rigid steel such as steel with high purity and strength made by Sanyo Steel Co., Ltd. Such a combination of steel and lubricating oil facilitates improvement in durability and commercialization.

As described above, the A and B toothed transmission sections of FIG. 1 are set in a case (12-FIG. 1) so that the base axes of the A and B toothed transmission sections are almost parallel to each other, and their contact surfaces opposite to each other are planes. The A and B toothed transmission sections have a fixed space between them, and the lubricant oil and the rotary member (8) are inserted in the space to be slidably in contact therewith. The friction action caused by the contact between the rotary member (8) and the lubricant oil enables the A input member and the B output member to be interlocked in variable transmission.

As for the movement of the rotary member (8), the function of the moving member (9) of the moving device (11) loaded with the rotary member rotataly in contact allows the rotary member to reciprocatingly move between the opposing A and B toothed transmission sections, and makes the contact position variable.

Specifically, the rotational force transmitted from the motor rotates the toothed transmission gear (2) of the A input member that is interlocked with the first toothed transmission section (7). The rotational force is transmitted to the rotary members (8) in contact with the A input transmission section and first transmission section (7) almost at a right angle, and at the same time as the rotary members (8) start rotational movement, the first toothed transmission section (7) interlocked by gears with the toothed transmission gear (5) of the B output member, both being in contact with the rotary members (8), start rotational movement to transmit torque. When the rotary member (8) is linearly moved from the set position near the center of the A toothed transmission gear (2) to a set position at the outer side of the A toothed transmission gear (2) by the moving device (11), it is also shifted from a set position at the outer side of the B toothed transmission gear (5) to a set position near the center of the B toothed transmission gear (5). The interlock of the A input member and the B output member via contact with the rotary member (8) results in a transmission ratio occurring.

The number of spheres or discs of the rotary members (8), which correspond to the A and B toothed transmission sections and the first toothed transmission section (7), can be increased to maximize torque (See FIG. 2). Further, with use of the sphere, which does not require a bearing, the bearing component can be omitted and the assembly process simplified, improving productivity, friction resistance, durability, and smooth movement.

Moreover, torque transmission by the interlock of the gears provided on the outer diameter side surface of the A and B toothed transmission sections of the A input member and the B output member and the gears provided on the outer diameter side surfaces of a plurality of (the combination of about a pair to sixteen pairs) the first toothed transmission sections (7) of FIG. 1, or, by the gear interlock of the gears (15) provided at the shaft portions of the input shaft (C) and the output shaft (D) and the gears (17) provided at the shaft portions of a plurality of (the combination of about a pair to sixteen pairs) transmission sections (16) of FIG. 3, can transmit high torque to low torque. Specifically, by increasing and decreasing the number of gears combined in the interlock of a plurality of gears of the first toothed transmission section (7) and the A and B toothed transmission sections of FIG. 1, or, the C and D transmission sections and the second gears (17) of FIG. 3, high torque to low torque can be transmitted.

The transmission occurs on one side of the toothed transmission gears and the first toothed transmission section (7) of FIG. 1, the second transmission sections (16) of FIG. 3, and the auxiliary transmission section (26) of FIG. 5. When the rotary member (8) reaches the outer side portions of each transmission section, the force causing oscillation at each transmission section becomes larger. However, because the position of the stabilizing member (29) of FIG. 4 for preventing oscillation almost corresponds to that of the rotary member's (8) in contact with the transmission section, it is possible to secure stable contact interlocking rotation.

### BRIEF DESCRIPTION OF THE DRAWINGS

FIG. 1 (Top Drawing) is a central sectional view of a continuously variable transmission showing a state in which an A toothed transmission section and a first toothed transmission section are interlocked according to claim 1 of the present invention, and FIG. 1 (Bottom Drawing) is a sectional view taken along A to A′;

FIG. 2 is a partial plan view showing a state in which rotary members (8), according to claim 1, interlock by contact only with the input transmission gear (2) at the center of four toothed transmission sections that are interlocked by gears;

FIG. 3 is a central sectional view of the continuously variable transmission showing a state in which a plurality of gears according to claim 2 are interlocked;

FIG. 4, is a central sectional view of the continuously variable transmission showing an E input member, an F output member, a rotary member (8), and a box (23) according to claim 3; and

FIG. 5 is a central sectional view showing a state in which a G input member and an H output member according to claim 4 are placed at a position to oppose an auxiliary transmission section (26).

### DETAILED DESCRIPTION OF THE PREFERRED EMBODIMENTS

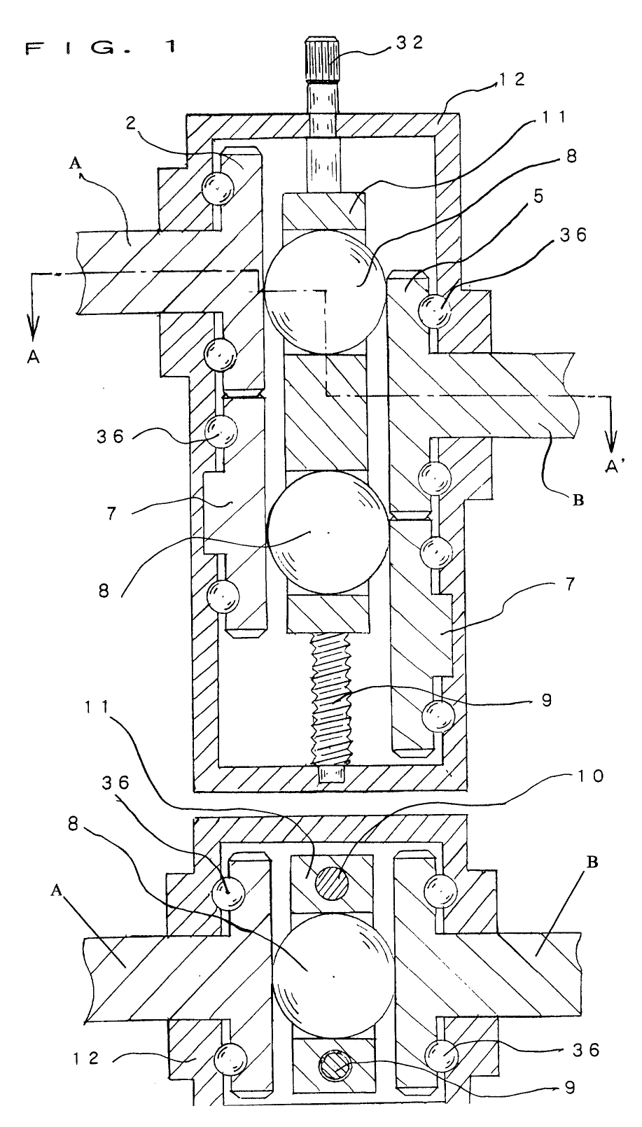

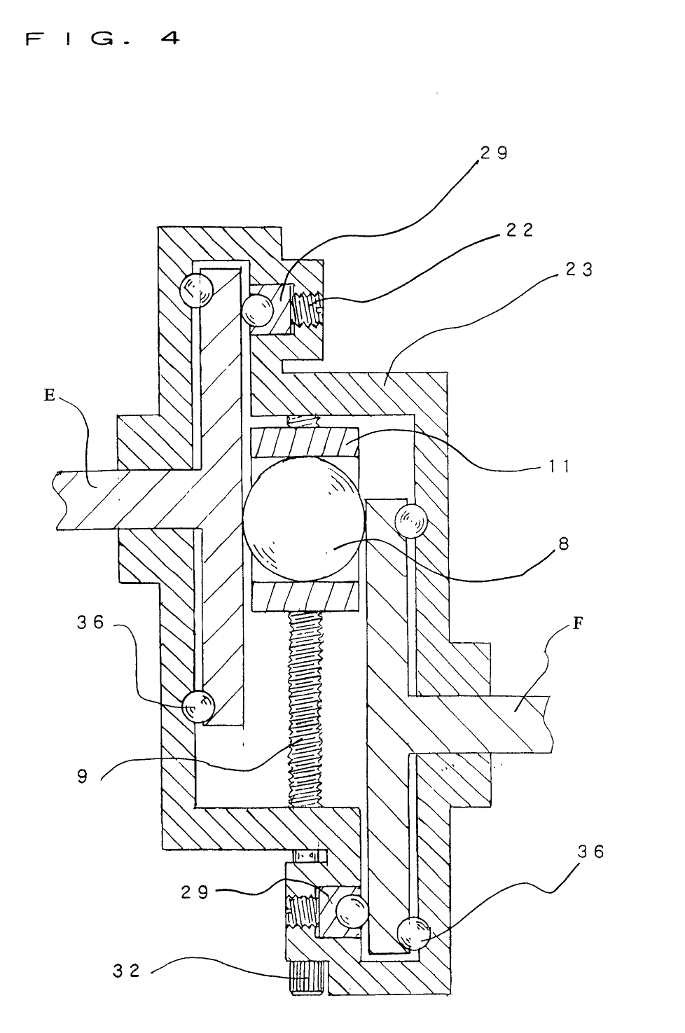

A continuously variable transmission of the present invention will be explained in detail below based on the drawings. In FIG. 1, an A input member and a toothed transmission gear (2) and a B output member and a toothed transmission gear (5) are mounted with a fixed space in between so that contacting surfaces of the toothed transmission gears (2, 5) oppose each other, and are placed to be axially supported by a box (12) with each base axis being maintained almost parallel to each other. A rotary member (8) is slidingly inserted in the space between the A and B toothed transmission sections and formed to be a sphere, or a disc (not shown). (A contact point can be made small by forming an outer diameter side face into a round shape). Variable transmission interlock can be achieved by the rotary member (8) in friction contact with the lubricant oil in the space provided between the A and B toothed transmission sections and a plurality of first toothed transmission sections (7) interlocked with the A and B toothed transmission gears (2,5). (At a gear ratio of 1:1, the combination of at least one pair to about six pairs, and with a change in the gear ratio, the number of pairs in combination can be increased, and higher torque can be transmitted). By increasing and decreasing the number of the first toothed transmission sections (7) in combination, low torque to high torque can be transmitted. FIG. 1 shows a state in which two spheres (8) are loaded in contact with a moving device (11), whereby double the pressing contact force can be obtained. A stabilizing member (29-FIG. 4) can be placed in a box (12) to be in contact with the A and B toothed transmission sections and a plurality of first toothed transmission sections (7), so that the A input and B output shafts and the first toothed transmission section (7) can be prevented from being inclined and can be maintained as parallel.

The method for moving the moving device (11) loaded with the rotary member (8), for example, can be with the use of a screw for a moving member (9). The moving device (11) is moved by the rotation of a screw (9) and can be linearly moved along an unthreaded shaft (10) for preventing the rotation of the moving device (11) caused by the rotation of the moving member (9). The method for rotating an interlock gear (32-FIG. 1) connected to the screw of the moving member (9) by gear interlock with a connecting gear provided at a drive motor (not shown) is by rotation of gear interlock (not shown) such as a spiral gear, worm gear, and the like. By penetrating bars fixed at matched mounting locations on each side of the moving device (11), and pressing the bar by cam action (not shown), the method for moving the moving device (11) can occur by providing a rack and pinion gear at a tip end portion of the bar and by interlocking the gears and the like.

The unthreaded shaft or baffle (10) for preventing the rotation of the moving device (11) caused by the rotation of the screw of the moving member (9) using screw rotation is a round shape, or a polygon. As another method, either a concave or a convex (not shown) is provided at each contacting portion of the inner side of the box (12) and the outer side of the moving device (11), and the concave and the convex are slidingly engaged with each other to be able to prevent the rotation of the moving device (11). The first toothed transmission section (7) can be placed at one side of the box (12) as shown in FIG. 1 or it can be placed at both sides (not shown). Further, if cushioning balls (36-FIG. 1) are placed at contacting portions between the box (12), the toothed transmission sections (2,5) and the first toothed transmission section (7), smooth rotation can be provided. In addition, the box, the toothed transmission gears (2,5) and the first toothed transmission section (7) can be prevented from being worn.

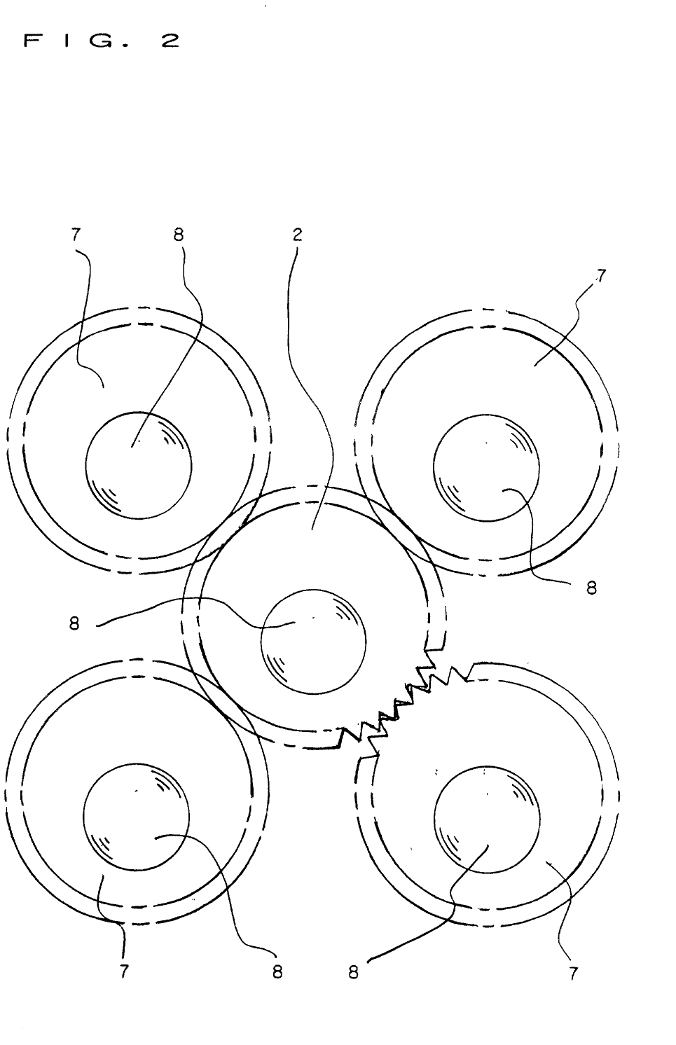

FIG. 2 shows a state in which four of the first toothed transmission sections (7) are placed at a circumference of the toothed transmission gear (2) of the A input member to perform gear interlock, and five rotary members (8) are placed rotataly in contact therewith, whereby torque transmission with a force of five times more is provided by gear interlock of the toothed transmission gear (2) and the first toothed transmission sections (7).

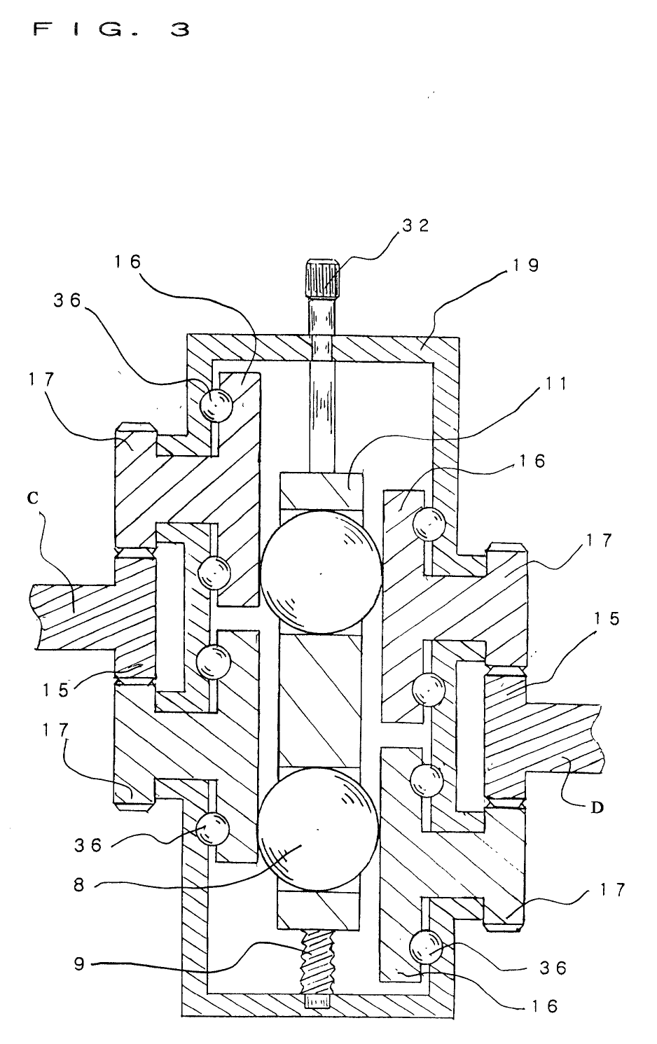

In FIG. 3, instead of providing the A input member, the B output member, and the first toothed transmission section (7), a C input shaft and a D output shaft are provided with first gears (15), and shaft portions of a plurality of second transmission sections (16) are provided with second gears (17) (At a gear ratio of 1:1, the combination of at least a pair to six pairs is made, and with a change in the gear ratio, the number of the pairs in the combination can be increased, so that higher torque can be transmitted.) Torque transmission can be achieved by gear interlock of the first gears (15) and the second gears (17). FIG. 3 shows a state in which two rotary members (8) are loaded in a moving device (11), whereby double the pressing contact force can be obtained. A stabilizing member (not shown) can be placed in a box (19) so as to be in contact with each of the second transmission sections (16), preventing the second transmission sections from being inclined and maintaining them in a parallel position. Cushioning balls (36) are provided at a contact portion between the second transmission sections (16) and the box (19), whereby smooth rotation can occur and wear of the contacting portions between the box (19) and the second transmission sections (16) can be prevented.

In FIG. 4, an E input member and a F output member are placed at a box (23), a rotary member (8) is loaded in a moving device (11), and the moving member (9) enables the moving device (11) to move. A stabilizing member (29) is attached to the box (23), and contact positions between the E input member and the F output member, and the stabilizing member can be adjusted by rotational adjustment of a tension pin (22) placed at the box, so that stable parallel rotation of the E input member and the F output member is maintained. Cushioning balls (36) are placed at contact portions between the E input member and the F output member and the box, whereby smooth rotation can occur and wear of the contacting portions between the box and the E input member and the F output member can be prevented.

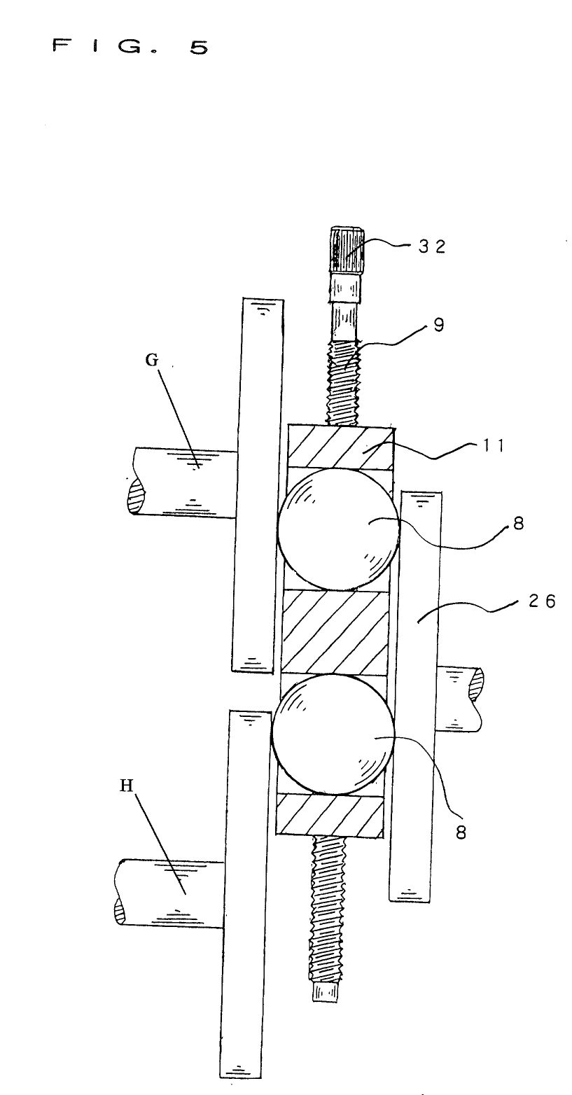

In FIG. 5, the G input member and the H output member are placed at a box (28, not shown) almost in parallel with each other, with an auxiliary transmission section (26) placed at a position to oppose them. A moving device (11) moves between the G input member and the H output member and the auxiliary transmission section (26). The rotary member (8) loaded therein moves in contact with the transmission sections, thus making it possible to achieve variable transmission.

Moreover, a single or a plurality of (the combination of about two to five) auxiliary transmission section (27, not shown) is or are between the G input member and the H output member opposing each other. The rotary members (8) loaded in moving devices (11), the number of which is corresponding to the G input member, the H output member, and the auxiliary transmission section (27) respectively, move in contact therewith, thus making it possible to achieve variable transmission. The G input member and the H output member can be placed so that each base axis is almost a straight line, or almost parallel in the reciprocating movement of the combination of a plurality of moving devices. The stabilizing members (29), the number of which corresponds to each transmission section and a plurality of auxiliary transmission sections, can be included. Cushioning balls (36) can also be included at contacting portions between each of the transmission sections and auxiliary transmission sections, and the box (28) (not shown).

Rotation occurs when there is contact with the rotary members (8) of each moving device (11), and such members are a sphere or a disc, or a ball bearing (not shown). Further, bearings of each input and output shaft, and each transmission section can be rotated in direct contact therewith, or can be slidingly rotated by means of a ball bearing (not shown) or a roller bearing (not shown). Cushioning balls (36) or roller bearings (not shown) may be circumferentially disposed continuously, spaced equally, or spaced unequally, whereby smooth rotation of the transmission section can be obtained. Further, a space adjusting screw (not shown) for adjusting a contact space between the contact surface of each transmission section and a rotary member (8) in contact therewith can be equipped at each box. Hence, it is possible to place the adjustment function (not shown) so as to be capable of adjusting the contact pressure of each transmission section and the rotary member (8) by moving the contact surface of each box mounted with each transmission section in the direction of the base axis of each transmission section by positional adjustment of the space for contact by rotation of the screw, or by a method of press adjustment by a repulsive force of a spring or the like.

As for the quality of the material of each component of the machine of the present invention, metal is basically used. High polymer can be used for transmitting low torque, which makes it possible to lessen the weight of the invention.

Further, the control of the movement of each moving device is performed according to a program previously set in a computer (not shown), serving to improve fuel consumption by adjustment of the rotation transmission ratio.

The present invention is widely applicable to all transmissions as a continuously variable transmission, and it is capable of performing a continuous or a stepwise variable operation of automatic-drive, manual-drive, or manual transmission of the motors (for vehicle equipment of motor-cycles, automobiles, electric cars and the like), (for aircraft equipment of aircraft, space ships and the like), (for rotation adjustment of disc drives of word processors, video and audio equipment, and the like), for belt conveyors, precision measurement devices, ship equipment, cinema equipment, printers, electric tools, medical devices, and the like.

A large transmission ratio can be obtained since the contact surface is constituted by a disc-shaped plane, and the spherical rotary member especially has small resistance in rotational contact, whereby smooth movement and wear resistance, and improvement in durability can be expected. By increasing and decreasing the number of a plurality of transmission sections in combination interlocked by gears disposed in one unit, lower torque to higher torque can be transmitted. Furthermore, a plurality of rotary members can be loaded in one moving device, and the movement of all the rotary members can be controlled at the same time by one movement control device, thus making the control method very simple, and serving to simplify the structure. The planar contact surface of the transmission section is easily machined, and makes it possible to perform smooth variable transmission without a shock caused by the gear change of the conventional transmission. Continuous variable transmission and weight reduction serve to reduce fuel consumption, preserve resources, and make the present invention economically feasible.

What is claimed is:

1. A continuously variable transmission, comprising
an A input shaft and a toothed transmission section (2) rotated by a drive source;
a B output shaft and a toothed transmission section (5) for taking out a driving force attributing a rotation of said output shaft;
a plurality of first toothed transmission sections(7);
a moving device (11) loaded with a rotary member (8), and includes a moving member (9) and an unthreaded screw or baffle (10); and
a box (12) for axially supporting and housing each member and device;
wherein said toothed transmission sections (2, 5) oppose each other, and said toothed transmission sections (2, 5) and said first toothed transmission section (7) each axially supported at said box (12) are interlocked by gears;
wherein the rotary member (8) is rotatably loaded in contact with said moving device (11);
wherein a space is provided between said toothed transmission sections (2, 5) for inserting the rotary member (8) and a lubricant oil to be in contact therewith, and said moving device (11) reciprocatingly moves in the space to interlock said toothed transmission gears (2, 5) and said first toothed transmission section (7) by contact via the rotary member (8), thereby making it possible to freely perform continuously variable transmission; and
wherein a value of torque transmitting force is increased and decreased according to the number of the first toothed transmission sections (7) combined.

2. The continuously variable transmission according to claim 1,
wherein instead of providing said toothed transmission gears (2, 5) and said first toothed transmission section (7) as in FIG. 1, first gears (15) are provided at shaft portions of a C input shaft and a D output shaft, second gears (17) are provided at shaft portions of a plurality of second transmission sections (16), and a moving device (11) and a box (19) are provided as shown in FIG. 3; and
wherein the first gears (15) and a plurality of second gears (17) are interlocked by gears, and torque transmission is performed by contact interlock between the rotary member (8) loaded in the moving device (11) and the second transmission sections (16).

3. The continuously variable transmission according to claim 1,
wherein the input and output members are an E input member and a F output member without interlocking gears being provided, and a box(23), as shown in FIG. 4; and
wherein torque is transmitted by contact interlock between the E input member and the F output member, and the rotary member (8) is loaded in a moving device (11).

4. The continuously variable transmission according to claim 1,
wherein the input and output members are a G input member and a H output member with no interlocking gears being provided, an A auxiliary transmission section (26) or a B auxiliary transmission section (27, not shown) is provided instead of said first toothed transmission section (7), and the box (28, not shown), as shown in FIG. 5;
wherein base axes of the G input member and the H output member are placed to be almost parallel to each other or almost a straight line; and
wherein the A auxiliary transmission section (26) is disposed at a position opposing the G input member and the H output member, and torque is transmitted by sliding interlock of the rotary member (8) by reciprocating movement of a moving device (11), or the auxiliary transmission section (27) is disposed between the G input member and H output member, and torque is transmitted by contact interlock of the rotary member (8) by a moving device (11).

5. The continuously variable transmission according to any one of claim 1, claim 2, claim 3, and claim 4, further comprising:
a stabilizing member (29) of FIG. 4 for preventing oscillation of each of said toothed transmission gears (2,5) and said first toothed transmission section (7) of FIG. 1, the first transmission section (15) and the second transmission section (16) of FIG. 3, the E input member and the F output member of FIG. 4, the G input member and the H output member and the auxiliary transmission section (26) and the auxiliary transmission section (27, not shown) of FIG. 5, which is provided at each of said box (12-FIG. 1), box (19-FIG. 3), box (23-FIG. 4) and box (28-FIG. 5, not shown).

6. The continuously variable transmission according to any one of claim 1, claim 2, claim 3, and claim 4,
wherein the rotary member (8) is formed to be a sphere.

7. The continuously variable transmission according to any one of claim 1, claim 2, claim 3, and claim 4,
wherein the rotary member (8) is formed to be a disc shape (not shown).

8. The continuously variable transmission according to any one of claim 1, claim 2, claim 3, and claim 4,
wherein a control of movement of the moving devices (11) is performed by a computer.
